(19) United States
(12) Patent Application Publication
(10) Pub. No.: US 2010/0268831 A1
(43) Pub. Date: Oct. 21, 2010

(54) Thin Client Session Management

(75) Inventors: James W. Scott, Cambridge (GB); Adin Scannell, Toronto (CA); Darren West, Chatteris (GB); Stephen E. Hodges, Cambridge (GB)

Correspondence Address: LEE & HAYES, PLLC, 601 W. RIVERSIDE AVENUE, SUITE 1400, SPOKANE, WA, 99201, US

(73) Assignee: Microsoft Corporation, Redmond, WA (US)

(21) Appl. No.: 12/425,009

(22) Filed: Apr. 16, 2009

(51) Int. Cl. G06F 15/16

(52) U.S. Cl. 709/228

(57) ABSTRACT

Thin client session management is described. In embodiments, a thin client device senses a usage context for the thin client device, and a process analyses the usage context to automatically select a session for the thin client device to connect to. Embodiments describe how the sensed usage context can indicate a location of the thin client device, movement of the thin client device, swapping of thin client devices or an identity of a user of the thin client device. Embodiments also describe how the thin client can be automatically authorized to access a selected session, based on the usage context. In other embodiments, a thin client device comprises a sensing device that can indicate a usage context for the thin client. Embodiments describe how the sensing device can determine that the thin client device is located in a docking station, and identify the docking station.

### BACKGROUND

Computers are becoming increasingly ubiquitous, and are becoming pervasively integrated into the environment. For many users, this introduces the issue of configuring, maintaining and managing operating systems, applications and data on a number of computers.

A thin client device is a client computer that operates in a client-server architecture. Thin clients are arranged to perform as little processing as possible, and the majority of the processing is performed by a server to which the thin client device is connected. This is in contrast to regular desktop or laptop computers (which can be considered “thick” clients), as the majority of the processing is performed on a local processor.

As the user's data, applications and operating systems are installed centrally on the server in a thin client architecture, the issue of configuring, maintaining and managing the computers becomes more manageable for the user. A single server can be arranged to support a large number of thin client devices. Furthermore, the lower amount of processing power used by a thin client device enables it to be made smaller and more power efficient than an equivalent “thick” client.

However, because a user's data and applications (known as the user's “session”) are predominantly located on the server thin client devices require effective session management and authentication schemes, in order to enable the user to reliably and securely access their session. This is exacerbated if the user uses a plurality of thin client devices to access the session.

The embodiments described below are not limited to implementations which solve any or all of the disadvantages of known thin client devices.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

Thin client session management is described. In embodiments, a thin client device senses a usage context for the thin client device, and a process analyses the usage context to automatically select a session for the thin client device to connect to. Embodiments describe how the sensed usage context can indicate a location of the thin client device, movement of the thin client device, swapping of thin client devices or an identity of a user of the thin client device. Embodiments also describe how the thin client can be automatically authorized to access a selected session, based on the usage context. In other embodiments, a thin client device comprises a sensing device that can indicate a usage context for the thin client. Embodiments describe how the sensing device can determine that the thin client device is located in a docking station, and identify the docking station.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 shows an example thin client system;

FIG. 2 shows a schematic diagram of a thin client device;

FIG. 3 shows a functional block diagram of the thin client system;

FIG. 4 shows a signaling diagram for a session selection process;

FIG. 5 shows a flowchart for a session selection algorithm;

FIG. 6 shows a signaling diagram for a session connection procedure and a session disconnection procedure;

FIG. 7 shows a flowchart of an automatic authorization algorithm;

FIG. 8 shows a flowchart of a session swap procedure;

FIG. 9 shows a signaling diagram for a session swap procedure;

FIG. 10 shows a signaling diagram for a manual session selection procedure;

FIG. 11 shows a signaling diagram for a configuration setting procedure;

FIG. 12 shows a graphical user interface dialog for a remote control application;

FIG. 13 shows example docking stations;

FIG. 14 shows an exemplary computing-based device in which embodiments of the thin client session management processes can be implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

Although the present examples are described and illustrated herein as being implemented in a wireless thin client system, the system described is provided as an example and not a limitation. As those skilled in the art will appreciate, the present examples are suitable for application in a variety of different types of computing systems.

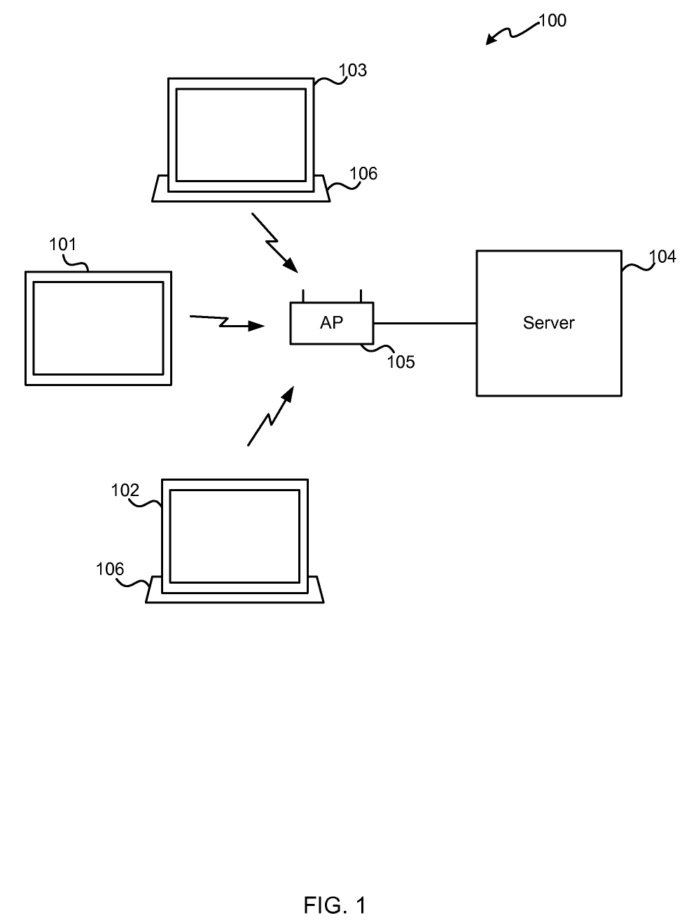

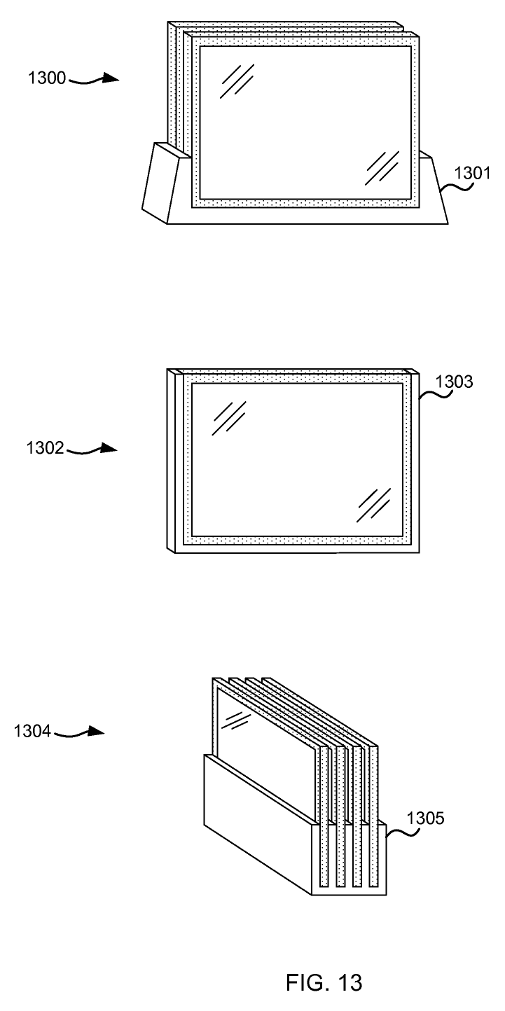

FIG. 1 illustrates an example thin client system 100. A plurality of thin client devices 101, 102, 103 are arranged to wirelessly communicate with a server 104 via an access point 105. One or more of the thin client devices 101, 102, 103 can be located in one or more docking stations 106, which can be in the form of a cradle or frame, as described hereinafter (with reference to FIG. 13). The docking station 106 can provide power to the thin client devices 101, 102, 103 for the purposes of powering the device and/or recharging batteries. The docking station 106 can also provide further features to the thin client devices, such as faster network access and other peripherals (e.g. a mouse, keyboard, USB ports, sound etc.)

Although there are multiple devices in the system of FIG. 1, the thin client architecture enables them all to be managed and configured centrally at the server 104. As almost all of the processing is performed on the server 104, the thin client devices 101, 102, 103 can be thin, light and power efficient portable terminals.

The thin client architecture enables any of the thin client devices 101, 102, 103 to perform any function interchangeably with each other. This is because the data relevant to the sessions that are running and being accessed by the different thin client devices 101, 102, 103 is present at a central point—the server 104. This therefore enables use-cases in which a user of a first thin client device 101 is accessing a session running on the server 104, and then swaps to a second thin client device 102 and continues to access the same session from the server 104. However, such interchangeability necessitates careful session management and user authorization if a plurality of thin client devices is to be used seamlessly and reliably.

In addition, in other examples, the thin client devices 101, 102, 103 can access multiple sessions running on multiple services. In other words, there can be additional servers to the server 104 shown in FIG. 1. These additional servers can be access via the same access point 105 as the server in FIG. 1, or via a different network connection. For example, a user of a thin client device 101 can use the thin client device 101 to seamlessly access sessions running on one or more work servers and one or more home servers.

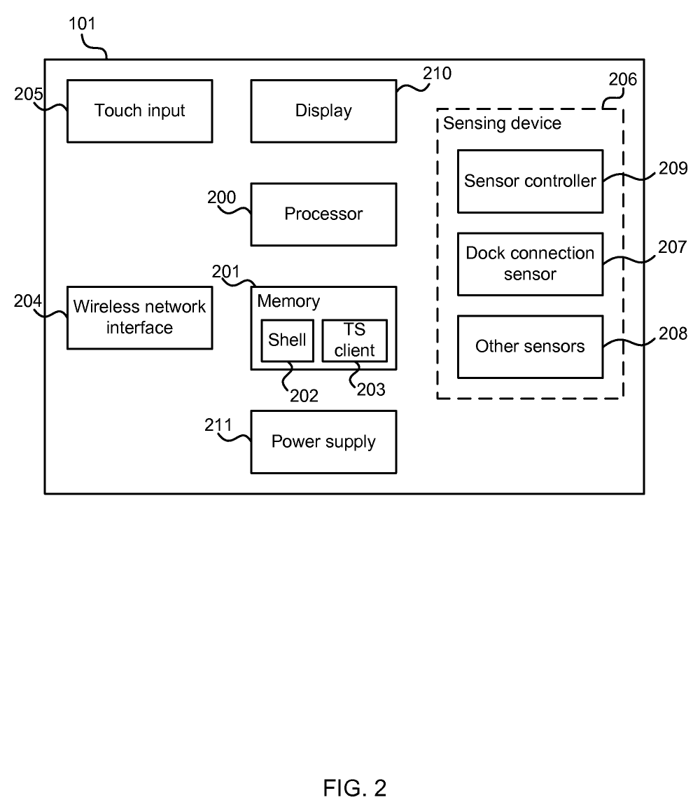

Reference is now made to FIG. 2, which illustrates an example of the hardware structure of the thin client device 101. The thin client device 101 comprises one or more processors 200, which can be microprocessors, controllers or any other suitable type of processors for processing computing executable instructions to control the operation of the device. The computer executable instructions can be provided using any computer-readable media, such as memory 201. The memory is of any suitable type such as random access memory (RAM), a disk storage device of any type such as a magnetic or optical storage device, a hard disk drive, or a CD, DVD or other disc drive. Flash memory, EPROM or EEPROM can also be used.

The memory 201 is arranged to store software that is able to be executed on the processor 200. The memory 201 of the thin client device stores a software shell 202 and a terminal server (TS) client 203 application, the functionality of which is described in more detail hereinafter.

A wireless network interface 204 enables the thin client device 101 to communicate over a wireless network with the server 104. The wireless network interface 204 can be, for example, a wireless local area network (WLAN) interface, a cellular radio interface, a personal area network (PAN) interface, or any other suitable interface for transmitting and receiving network data. Note that in other examples, a wireless network interface can be replaced with a wired communication interface.

The thin client device 101 can also receive user input, for example touch input 205 from a user's finger, pen or stylus. The thin client device 101 receives further input from a sensing device 206. The sensing device 206 provides the processor 200 with information regarding the context in which the thin client device 101 is being used. In other words, the sensing device 206 provides data on the current usage circumstances, environment or state of the thin client device 101.

The sensing device 206 comprises a dock connection sensor 207, which is arranged to detect the presence of the thin client device 101 in a docking station 106, and provide information regarding the docking station 106 to the processor. The sensing device can also comprise other sensors 208, which can include, for example, accelerometers, global positioning system (GPS) sensors, biometric sensors (such as a fingerprint reader, face detection camera or iris scanner), radio-frequency identification (RFID) readers, and short-range wireless transceivers (such as Bluetooth, ultra-wideband, or near-field communication transceivers).

The sensing device 206 also comprises a sensor controller 209, which is arranged to control the dock connection sensor 207 and other sensors 208, and provide the data from these sensors to the processor 200. By having a sensor controller 209 that is separate from the processor 200, the data from the sensors can be read and utilized even when the processor 200 is idle or deactivated. For example, the sensor controller 209 can be a low power device that can monitor the sensor inputs whilst the remainder of the thin client device 101 is deactivated, and when an appropriate sensor input is received the sensor controller 209 can trigger the processor 200 to activate the thin client device 101. For example, the thin client device 101 can be arranged to activate when movement from an accelerometer is sensed.

Output to the user of the thin client device 101 can be provided by a display 210. The display 210 can be integrated with the touch input 205 to provide a touch-sensitive display. The thin client device 101 further comprises a power supply 211 such as a battery.

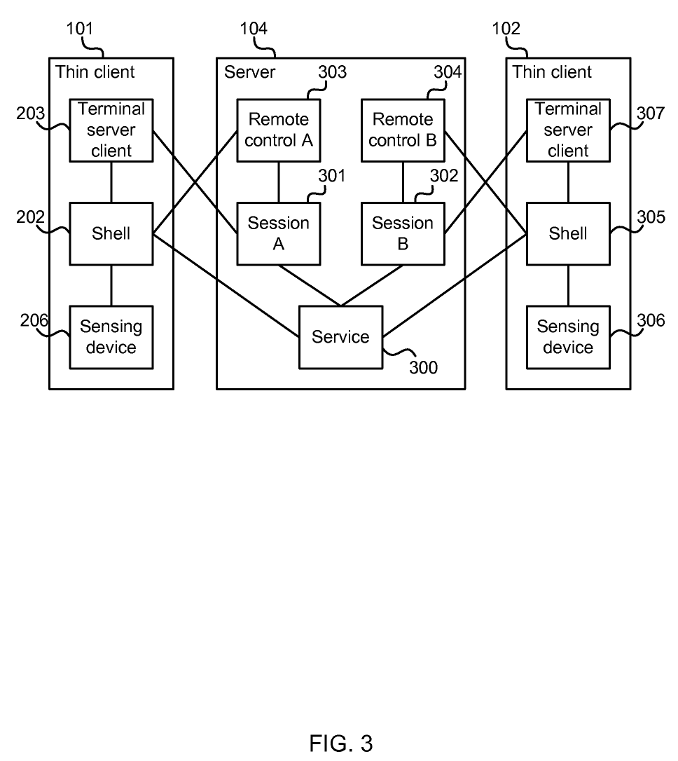

Reference is now made to FIG. 3, which illustrates an example functional block diagram of the elements in a thin client system comprising thin client devices 101, 102 and the server 104. A first thin client device 101 comprises a shell 202, a terminal server client 203 and a sensing device 206, as mentioned above. The shell 202 is a lightweight control program that controls the basic operation of the first thin client device 101. In particular, the shell determines what sessions are available on the server 104, and provides an interface on the display for the user to select a session to log into. The terminal server client 203 is a program that enables the user to interact with a particular session, and view the user interface of the session on the display of the thin client device 101.

The server 104 comprises a software service 300 which is arranged to control and manage a plurality of sessions executed on the server 104. In the example shown in FIG. 3, two sessions are running on the server 104: session A 301 and session B 302. In other examples, more sessions could also be running on the server 104 as well. Also note that the service 300 and sessions 301, 302 do not have to be running on the same physical server 104 as shown in FIG. 3, but can be running on different servers in communication with each other.

In yet further examples, additional sessions can also be running on one or more other servers (i.e. not on server 104). These additional services can be under control of the service 300 running on server 104. Alternatively, these additional services can be under control of one or more additional services running on another server, and the one or more additional services can communicate with service 300 to act together and provide the same functionality as if only a single service was present.

Each session corresponds to applications and data that are accessible to one or more users. A session can comprise either a user interface of a remote desktop (i.e. a complete view of a computer desktop with several accessible applications) or one or more individual applications. For example, session A 301 could correspond to a first user using a word processing application in a Microsoft Windows™ desktop, and session B 302 could be a stand-alone calendar application that is accessible to several users. In one example, the session is provided to the TS client 203 using the remote desktop protocol (RDP), which enables both desktop and application remoting. In addition, the thin client device 101 can aggregate multiple sessions, for example such that one application or desktop is provided by one session, and another application is provided by another session (which can be on a different server). This can be achieved using either a modified TS client 203 which can itself aggregate sessions, or it can be achieved using multiple instances of a TS client 203 concurrently.

Each session 301, 302 on the server 104 is optionally executing a software remote control 303, 304. The remote control 303, 304 enables the user in a session to change settings of the thin client device (even though the remote control is on the server, and not on the thin client device itself). These settings include aspects such as the display brightness and the time for which the thin client device 101 is idle until the device enters a suspend mode.

In the example of FIG. 3, the first thin client device 101 is accessing session A 301. The shell 202 receives data from the sensing device 206, and communicates with the TS client 203 and the service 301 on the server 104. Session A 301 communicates with the TS client 203 and remote control A 303. Remote control A 301 communicates with the shell 202 on the first thin client device 101.

The server 104 in FIG. 3 is also shown connected to a second thin client device 102. The second thin client device 102 has a similar structure to the first thin client device 101 in that it comprises a shell 305, a sensing device 306 and a TS client 307. The second thin client device 102 is shown accessing session B 302 in FIG. 3.

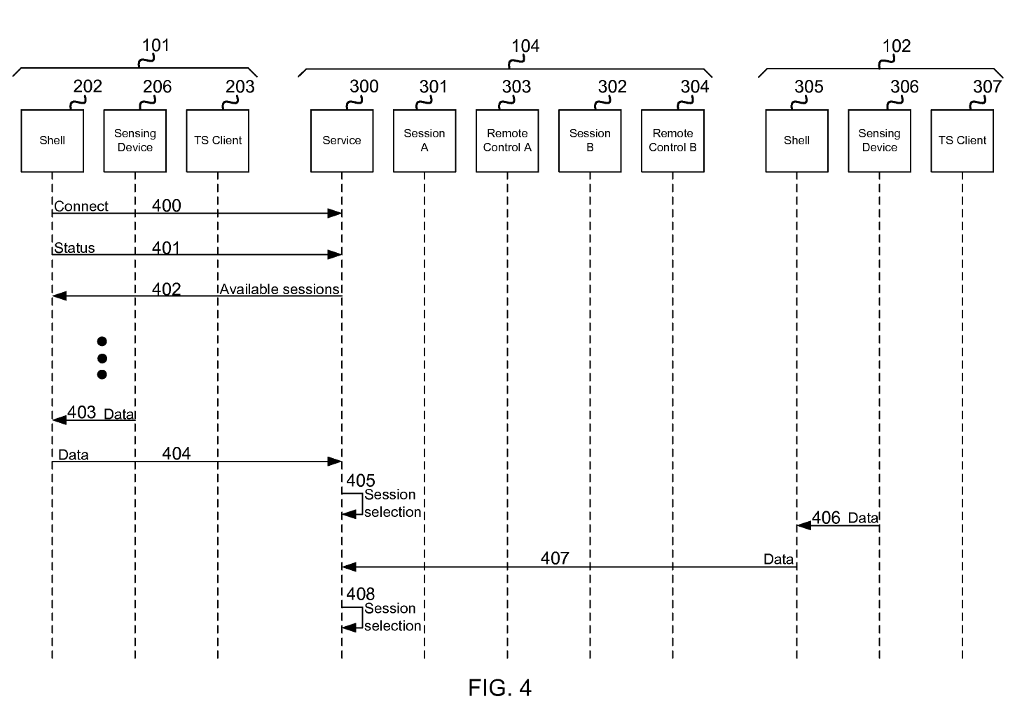

The structure of FIG. 3 is configured to support interchangeability between thin client devices. For example, the server is arranged to keep all state, including thin client device configuration (such as display brightness and suspend idle time) associated with sessions rather than specific devices. Automatic association of thin client devices to particular sessions based on a sensed usage context provided by the sensing device is enabled, and different levels of secure authorization can be provided in different circumstances. The server is also arranged to detect swapping of thin client devices and react by automatically swapping sessions, and not requiring re-authorization if a device is swapped. These aspects are outlined in more detail with reference to the processes shown in FIGS. 4 to 10.

Reference is first made to FIG. 4, which illustrates a process by which a thin client device 101 can have a session automatically selected and connected. FIG. 4 illustrates the process from the perspective of a first thin client device 101 and a second thin client device 102, both connected to a server 104 that has two sessions, session A 301 and session B 302 available. In other examples, a different number of thin client devices and sessions can be present.

When the thin client device 101 is first activated, the shell 202 of the thin client device 101 connects 400 to the service 300 on the server 104. The shell 202 provides the service with a status message 401 indicating the current status of the thin client device 101, for example including battery life remaining and display brightness. Note that, in other examples, messages 400 and 401 can be integrated into a single message. The service 300 provides the shell 202 with a list of available sessions 402 that are present on the server 104. At this point the shell 202 can display a selection dialogue for the user to choose to connect to a session. Note that the provision of the status message 401 and available sessions 402 does not have to be performed in the order shown in FIG. 4.

After some time has elapsed, the sensing device 206 senses an event and provides data 403 relating to the sensed event to the shell 202. The shell 202 transmits a message 404 comprising the sensor data to the service 300 for processing. Note that the sensing device can be arranged to provide periodic updates of certain data to the shell 202, and therefore there can be many transmissions of the data to the service 300, rather than the single transmission shown in FIG. 4. Note that not all the data from the sensing device 206 is necessarily transferred to the service 300. The sensing device 206 itself can filter data that is uninteresting, or the shell 202 can filter the data before it sent to the service 300.

The data 403 from the sensing device can be of a variety of different forms. For example, if the thin client device 101 is placed into a docking station 106, then the dock connection sensor 207 can provide the identity of the docking station as the data. In another example, if the sensing device 206 comprises a GPS sensor, then the data comprises location information. In another example, if the sensing device 206 comprises an RFID reader, then the data comprises information read from an RFID tag in the vicinity of the thin client device 101. If the sensing device 206 comprises a biometric sensor, then the data comprises biometric data (such as a fingerprint). Alternatively, if the sensing device 206 comprises a wireless transceiver, then the data can comprise the identity of a wireless transmitter in the vicinity of the thin client device 101.

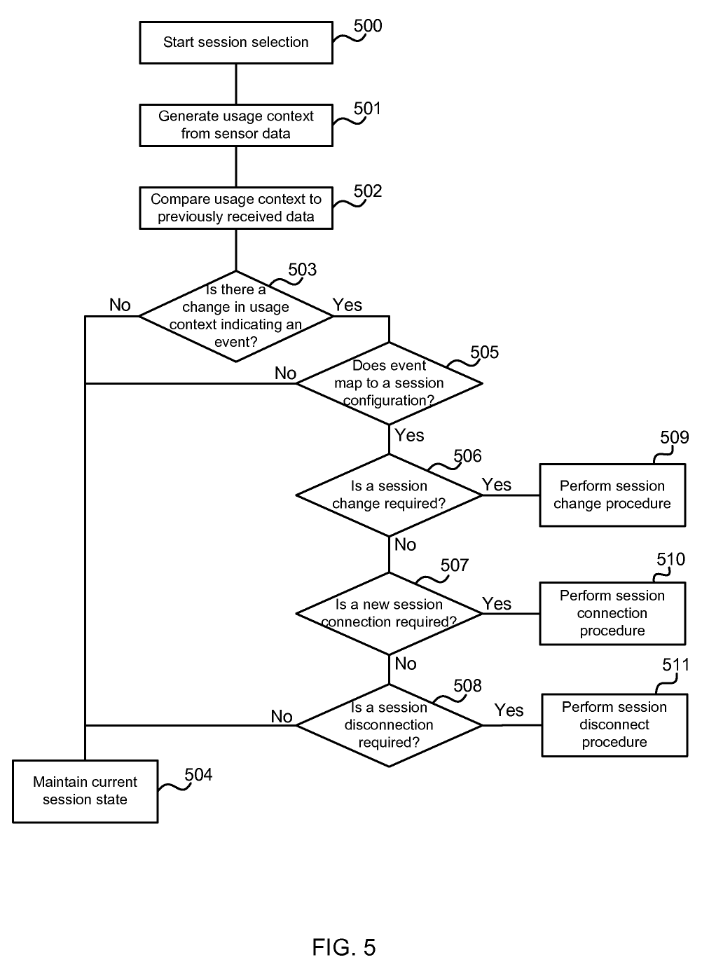

When the service 300 receives sensor data from the thin client device 101 it executes 405 a session selection algorithm. The session selection algorithm is described presently in more detail with reference to FIG. 5.

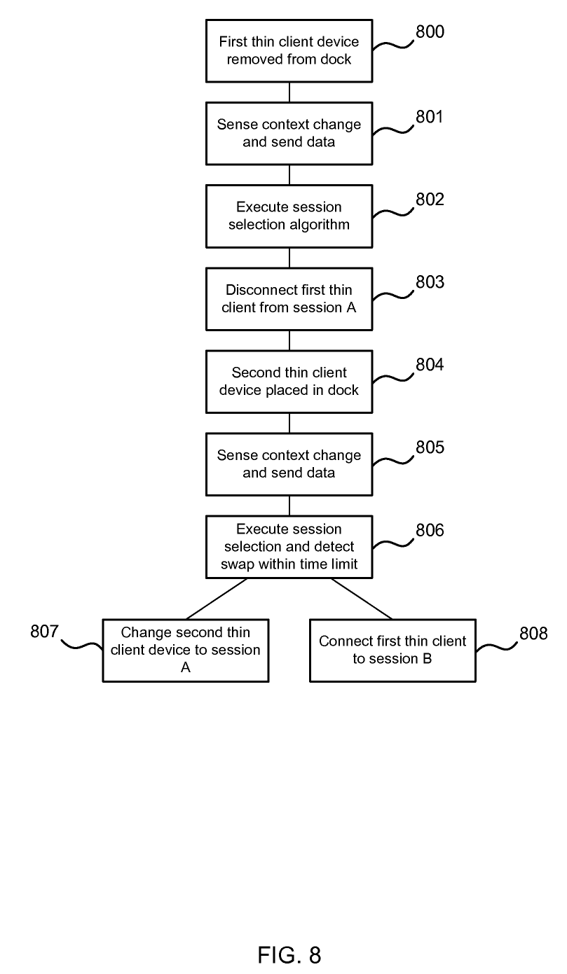

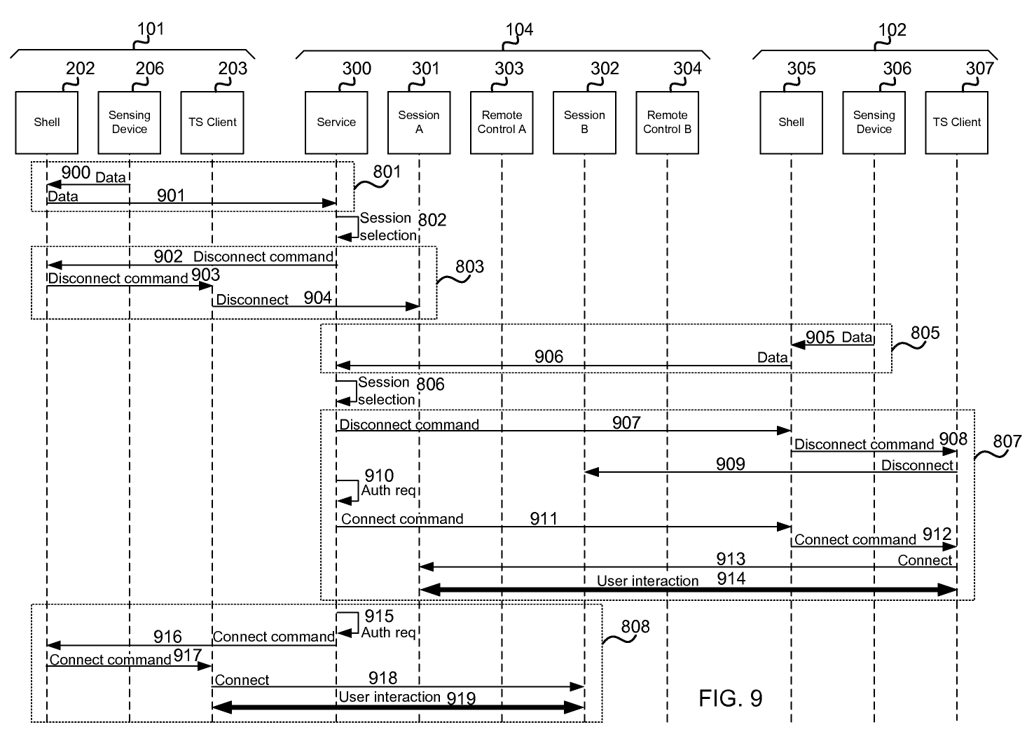

The service 300 can also, optionally, receive further sensor data from one or more other thin client devices, such as data 406 from the sensing device 306 of the second thin client device 102 in FIG. 4, which is sent in a message 407 to the service 300 from the shell 305. The receipt of this message 407 at the service can optionally trigger a further session selection algorithm execution 408. This situation is discussed in greater detail with reference to FIGS. 8 and 9 below.

Referring now to FIG. 5, when the session selection algorithm is started 500, the service 300 analyses the received sensor data to generate 501 a usage context for the thin client device 101. The usage context is a determination of the current status, situation or environment of the thin client device 101. Two example usage contexts are that the thin client device is at a certain location, and/or that the thin client device is being used by a certain user. However, it should be noted that for certain types of sensor data the analysis performed does not have to translate the data to generate a higher-level interpretation of the data. In other words, the data itself can directly reflect the usage context and the analysis corresponds merely to reading the content of the data.

For example, considering first location-based usage contexts, if the sensor data is related to the identity of a docking station 106, then the service 300 knows that the thin client device 101 is located in the identified docking station 106. In another example, if the sensor data is related to the GPS location of the thin client device 101, then the service 300 can determine that the thin client device is used in a particular room or building. In a further example, if the sensor data indicates the identity of a wireless transmitter, then the service can determine that the thin client device 101 is in the vicinity of the wireless transmitter, the position of which can be known to the service 300.

In the case of user identity-based usage contexts, if the sensor data comprises biometric data (such as a fingerprint) then the service 300 can generate the identity of the user from this biometric data (e.g. looking up the user identity having a given fingerprint). Similarly, if the sensor data contains information read from an RFID tag in the vicinity of the thin client device 101, then the service 300 can determine whether this information relates to a specific user (e.g. if the user has an RFID access card or key-fob).

The generated usage context is then compared 502 to previously received data, and it is determined 503 whether a change in usage context has occurred that indicates an event has occurred. The events relate to real-world actions on the part of the user of the thin client.

Example events include the placement or removal of the thin client device 101 in a docking station (i.e. the usage context changes such that the thin client device is now located in a docking station, or vice versa), that the thin client device has been moved to a particular location (e.g. due to a change in the GPS location or the presence of a known wireless transmitter), or that a certain user has started using the thin client device (i.e. the usage context has identified a particular user of the device, who was not previously using it).

One particular type of event is a thin client device swap event. A swap event occurs when a user exchanges one thin client device for another. For example, if the user's current thin client device is running out of batteries, then the user can swap the current thin client device for another in a docking station. Such a swap event is detected by the session selection algorithm due to a first thin client device leaving a certain location (causing a change in usage context of the first thin client device) and a short time later a second thin client device takes the previous position of the first thin client device (causing a particular change in usage context of the second thin client device within a time period of the first thin client device's context change).

If the usage context has not changed, then the current session (if any) in use on the thin client device 101 is maintained 504. If, however, the usage context has changed such that it is determined that an event has occurred, then it is determined 505 whether the particular event detected can be mapped to a specific session configuration. Certain events map directly to certain sessions, whereas others indicate that sessions can be disconnected.

For example, the placement of a thin client device 101 in a particular docking station can associate that thin client device to a particular session. Docking stations can be placed in specific locations in a home, and allocated certain sessions that are activated whenever the thin client device is in that docking station, e.g. a hallway docking station can be associated with a family calendar session, such that this is displayed when the thin client device is placed in this docking station, whereas a bedroom docking station can be associated with a news and weather display session.

Conversely, the removal of a thin client device 101 from a docking station can disconnect that device from the session associated with that docking station 106.

In another example, the identification of a particular user using the device can associate that thin client device 101 to that user's personal session. Alternatively, the movement of the thin client device 101 to a particular room associated with a user can result in a certain user session being connected.

The above-described associations of events to certain sessions (or disconnection from sessions) can be predefined by the user of the thin client system. If it is determined that the detected event does not relate to a certain session configuration, then the current session state is maintained 504.

If, however, the determined event does relate to a certain session configuration, then it is determined whether it is appropriate to change 506 a current session on the thin client device 101 to a new session, whether a new session connection 507 is appropriate (if the device is currently not connected to a session), or whether it is appropriate to disconnect 508 the thin client device 101 from the current session. If none of these options apply, then the thin client device 101 is already connected to the most appropriate session, and this is maintained 504.

If it is appropriate to change 506 the current session on the thin client device 101 to a new session, then a session change procedure 509 is performed. If it is appropriate to connect 507 a new session, then a session connection procedure 510 is performed. If it is appropriate to disconnect the thin client device 101 from the current session, then a session disconnect procedure 511 is performed.

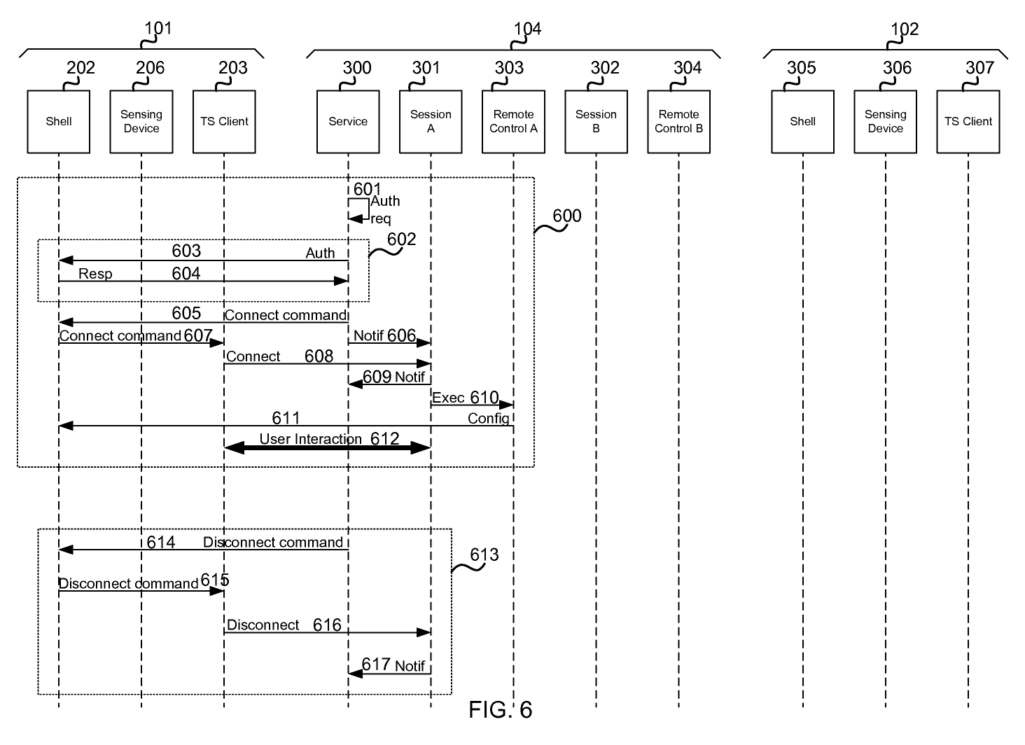

Each of the different results from FIG. 5, namely connecting a new session, disconnecting a session, or changing a session are now described below with reference to FIG. 6.

Reference is first made to box 600 in FIG. 6, which illustrates the session connection procedure (as discussed with reference to block 510 in the flowchart of FIG. 5). Firstly, before the connection procedure is started, an automatic authorization process 601 is used to determine whether to obtain user authentication before the user can access the requested session.

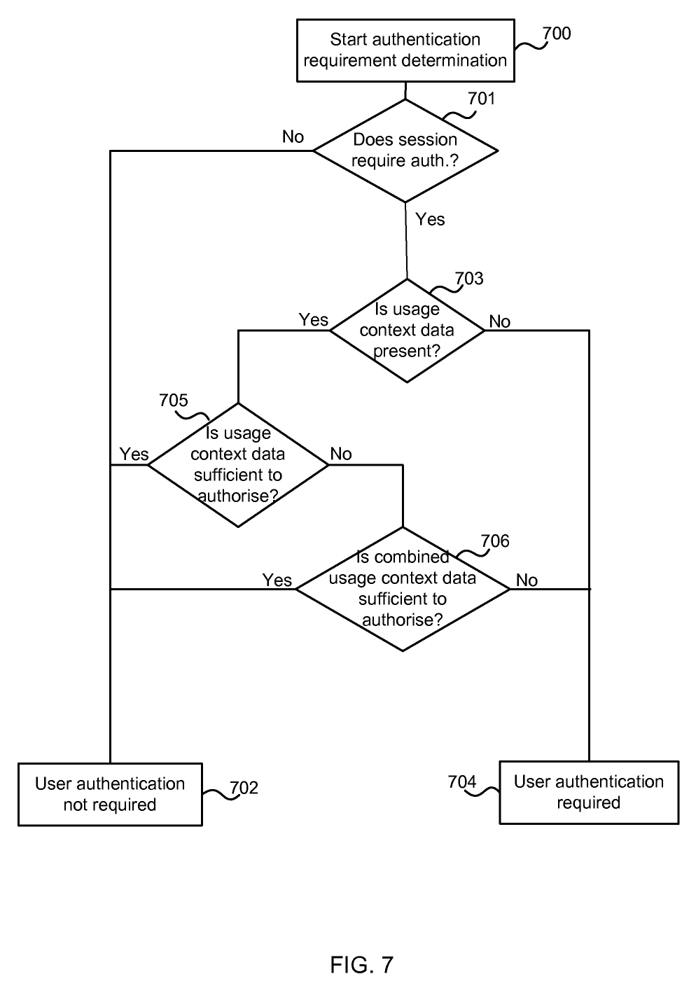

The automatic authorization process for determining whether to obtain authentication is now described with reference to FIG. 7. Once the automatic authorization process is started 700, it is determined 701 whether the session in question requires authentication. Certain sessions can be specified as having no user authentication requirements. If this is the case, then the result of the process is that user authentication is not required 702.

If however, the session does require authentication, then it is determined 703 whether usage context data is present from the sensing device 206. If usage context data is not present, then the result of the process is that user authentication is required 704. If usage context data is present, then it is determined 705 whether the usage context data provided by the sensing device 206 is sufficient to authorize the user to access the session in question. For example, if the usage context was able to identify the user, e.g. using biometric data or an RFID tag, then this is sufficient authorization for the user. Similarly, if a thin client device is placed in a docking station that has been assigned to a specific session, then the detection of the presence of the docking station is sufficient authorization to connect to the session. Note, however, that the docking station can in some examples be a equipped with its own authentication module (e.g. a trusted platform module (TPM)) arranged to authenticate the docking station with the server, so that a malicious user is not able to fake the docking station identity and avoid user authentication.

Furthermore, the context data considered can also include a history of thin client device events that have occurred previously. For example, it can be determined 705 that the thin client device 101 was logged-out from the session in question up to a certain time limit into the past, and this can be taken to be sufficient to authenticate the user. For example, if a thin client device 101 was located in a docking station 106, and was displaying a calendar session, and the user removed the thin client device from the docking station, then this causes the thin client device to be logged-out of the session. The user may wish to continue viewing the calendar and manually select to connect back to the calendar session. As the thin client device was connected to this session within a predetermined time period into the past, it is determined that the context data is sufficient to authenticate the user (i.e. the user can re-connect without requiring further authentication).

If the context data is sufficient to authorize the user, then the result of the process is that user authentication is not required 702. If this is not the case, then it is determined 706 whether a combined usage context data taking into account usage context data from other thin client devices is sufficient to authorize the user to access the requested session. For example, if two thin client devices are being exchanged, such that a swap event is occurring (as described in more detail with reference to FIG. 8), then it can be determined that the session that is being swapped between the thin client devices has been previously authorized for this user. As the session has been previously authorized, it can be swapped between thin client devices without requiring re-authentication 702. However, if the combined usage context data is sufficient not sufficient to authenticate the user, then further user authentication is required 704.

Returning again to FIG. 6, if further authentication by the user is to be obtained, then the messages in box 602 are sent. Otherwise, if further authorization is not required, then these messages are skipped. If authorization is to be obtained, then an authorization request message 603 is sent from the service 300 to the shell 202, and a response message 604 containing the requested authorization credentials from the user are sent back to the service 300. The authorization can be in the form of a PIN number, password or any other suitable authorization technique. In another example, the request message 603 is not required, as the shell 202 can already know the authentication requirements for the session, if they are associated with session details previously received from the service 300.

The service 300 then sends a connection command 605 to the shell 202 requesting the shell to connect to the selected session. The connection command 605 can also include authorization credentials for the shell 202 to pass to the TS client 203, in order to enable the TS client 203 to authenticate with the session. For example, this can be in the form of a one-time authentication certificate for that thin client device to connect to a specific session securely.

Optionally, the service 300 also sends a notification message 606 to the selected session (e.g. session A 301) indicating that the thin client device 101 is connecting to the session, and has been authorized. The shell 202 sends a connection command 607 to the TS client 203 requesting a connection to session A 301. The TS client 203 then initiates a connection 608 to session A 301. Once the session connection has been established, session A 301 sends an optional notification message 609 the service 300 indicating that the session is active with the thin client device 101.

Preferably, session A 301 executes 610 the remote control A 303 application (if it is not already running), and remote control A 303 transmits the thin client configuration parameters 611 (such as display brightness and suspend idle time) associated with this session to the shell 202. The shell applies these parameters to the thin client device 101.

The user can then use the thin client device 101 to interact 612 with session A 301. From the perspective of the user of the thin client device 101, when the session is connected, there is little perceivable difference compared to a “thick” client computer, even though the session is running on the server 104 and not on a local processor. In addition, the thin client device settings associated with this session are automatically sent to the thin client device and applied, without any direct user input.

Reference is now made to box 613 in FIG. 6, which illustrates the session disconnect procedure (as discussed with reference to block 511 in FIG. 5). The service 300 transmits a disconnect command 614 to the thin client shell 202. The shell 202 passes the disconnect command 615 to the TS client 203. The TS client 203 disconnects 616 from session A 301, and session A 301 optionally sends a notification message 617 to the service 300 to inform the service 300 of the disconnection. Note that the procedure shown in box 613 relates to procedure performed as a result of the session selection algorithm (i.e. block 511 in FIG. 7). In addition, disconnections can occur due to the shell 202, the remote control 303, or the session 301 generating a disconnection command or a disconnection notification.

The session change procedure (as discussed with reference to block 509 in FIG. 5) is a combination of the disconnect procedure of box 613 and the connection procedure of box 600. The session change procedure firstly disconnects an existing session, and then connects a new session to the thin client device 101, as described above with reference to FIG. 6.

Reference is now made to FIGS. 8 and 9, which illustrate a session swap procedure. As mentioned, a swap event is a particular event where a user exchanges one thin client device for another. For example, the user can determine that the current thin client device that he is using is running out of batteries, and can swap this thin client device for another in a docking station. A swap event is therefore indicated by a first thin client device leaving a certain location (e.g. a docking station) and a short time later a second thin client device takes the previous position of the first thin client device. The session swap procedure detects the swap event and exchanges the sessions connected to two thin client devices, preferably without requiring re-authorization by the user.

In the example in FIGS. 8 and 9, the first thin client device 101 is swapped from session A 301 to session B 302, and the second thin client device 102 is swapped from session B 302 to session A 301. This can occur for example if the first thin client device 101 is initially in a docking station 106 showing session A 301, and a user is using the second thin client device 102 with session B 302. The user then removes the first thin client device 101 from the docking station 106, and places the second thin client device 102 in the docking station 106 instead. The sessions active on the two thin client devices rapidly swap over, enabling the user to continue using session B 302, but now on the first thin client device 101.

FIG. 8 shows the general steps performed during a swap procedure, and FIG. 9 illustrates the operation of the session swap procedure. Note that optional notification messages and the communication with the remote controls are not illustrated in FIG. 9 for clarity, but can be included as described in FIG. 6.

A session swap event starts when a first thin client device 101 is removed 800 from a dock 106. The first thin client device 101 senses the change due to leaving the dock 106, and sends data 801 reporting this to service 300. This is illustrated in FIG. 9, where the sensing device 206 sends data message 900 to the shell 202, and this is sent to the service 300 in data message 901. When the service 300 receives the data message 901, the session selection algorithm of FIG. 5 is executed 802. The result of this is to disconnect the session A 301 (due to leaving the dock).

The thin client device 101 is then disconnected 802 from session A 301 using a disconnect procedure as described with reference to box 613 in FIG. 6. With reference to FIG. 9, a disconnect command 902 is sent from the service 300 to the shell 202. The shell 202 passes the disconnect command 903 to the TS client 203. The TS client 203 disconnects 904 from session A 301. The second thin client device 102 is placed 804 in the dock 106 from which the first thin client device 101 was just removed. Note that the placement of the second thin client device 102 in the dock 106 can occur in parallel with the disconnection of the first thin client device 101. The second thin client device 102 senses the change due to being placed in the dock 106, and sends data 805 reporting this to service 300. This is shown in FIG. 9, where the sensing device 306 sends data message 905 to the shell 305, and this is sent to the service 300 in data message 906.

When the service 300 receives the data message 906, the session selection algorithm of FIG. 5 is executed 806. There are two outcomes from the session selection algorithm. Firstly, the session of the second thin client device 102 is changed 807 from session B 302 to session A 301 (due to being placed in the dock 106). Secondly, it is detected that the second thin client device 102 was placed in the dock 106 within a predefined time limit of the first thin client 101 leaving the dock 106. The session selection algorithm determines that a swap event has occurred, and that the first thin client device 101 is to be connected 808 to session B 302.

In FIG. 9, the second thin client device 102 is changed 807 from session B 302 to session A 301 by the service 300 sending a disconnect command 907 to the shell 305. The shell 305 sends the disconnect command 908 to the TS client 307, which disconnects 909 from session B 302. The service 300 checks the authentication requirements 910 for session A 301, and no authentication is required as the second thin client device 102 was placed in the dock 106, which is sufficient authentication. A connect command 911 is then sent from the service 300 to the shell 305, and the shell 305 sends a connect command 912 to the TS client 307. The TS client 307 connects 913 to session A 301, and the session with the second thin client device 102 is established 914.

The first thin client device 101 is connected 808 to session B 302 by the service 300 firstly checking the authentication requirements 915 for the first thin client device 101 to access session B 302. Because this is a swap event, the user does not need to be re-authenticated (as described above with reference to FIG. 7). The service 300 then issues a connection command 916 to the shell 202, and the shell 202 sends a connection command 917 to the TS client 203. The TS client 203 then connects 918 to session B 302. The user can then use the first thin client device 101 to interact 913 with session B 302 instead of using the second thin client device 102. Note that the session change 807 of the second thin client device 102 and the session connect 808 of the first thin client device 101 can be performed in parallel, or in a different order to that shown in FIG. 9.

Therefore, the process in FIGS. 8 and 9 has rapidly swapped the sessions active on two thin client devices automatically, without requiring any direct user input.

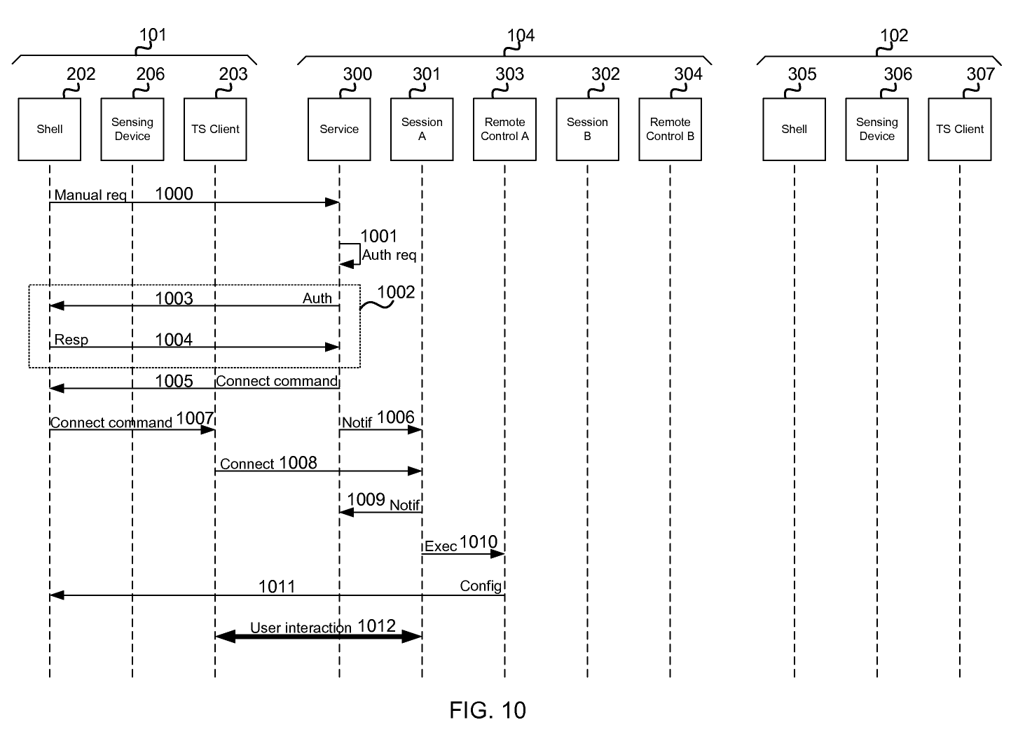

Reference is now made to FIG. 10, which illustrates a process by which a user can manually select a session on the thin client device, and be automatically authorized to access that session. This can occur, for example, if the user removes a thin client device from a docking station, which automatically logs the thin client device out from its docked session, but then the user manually selects to re-connect to that session.

A manual request message 1000 is sent from the shell 202 to the service 300. The service 300 then performs the automatic authorization process 1001, as outlined above with reference to FIG. 7. This enables the user to log into the session without further authorization if the thin client logged out of the session less than a predetermined time period into the past.

Following the automatic authorization procedure, the process is similar to that outlined in FIG. 6. If further authorization by the user is to be obtained, then the messages in box 1002 are sent. Otherwise, if further authorization is not required, then these messages are skipped. If authorization is to be obtained, then an authorization request message 1003 is sent from the service 300 to the shell 202, and a response message 1004 containing the requested authorization credentials from the user are sent back to the service 300. The service 300 then sends a connection command 1005 to the shell 202 and an optional notification message 1006 to session A 301 to indicate that the thin client device 101 is connecting to the session, and has been authorized. The shell 202 sends a connection command 1007 to the TS client 203 and the TS client 203 then initiates a connection 1008 to session A 301.

When the session connection has been established, session A 301 sends an optional notification message 1009 to the service 300 indicating that the session is active, and session A 301 optionally executes 1010 remote control A 303, which transmits the thin client configuration parameters 1011 associated with this session to the shell 202. The shell 202 applies these parameters to the thin client device 101. The user can then use the thin client device 101 to interact 1012 with session A 301.

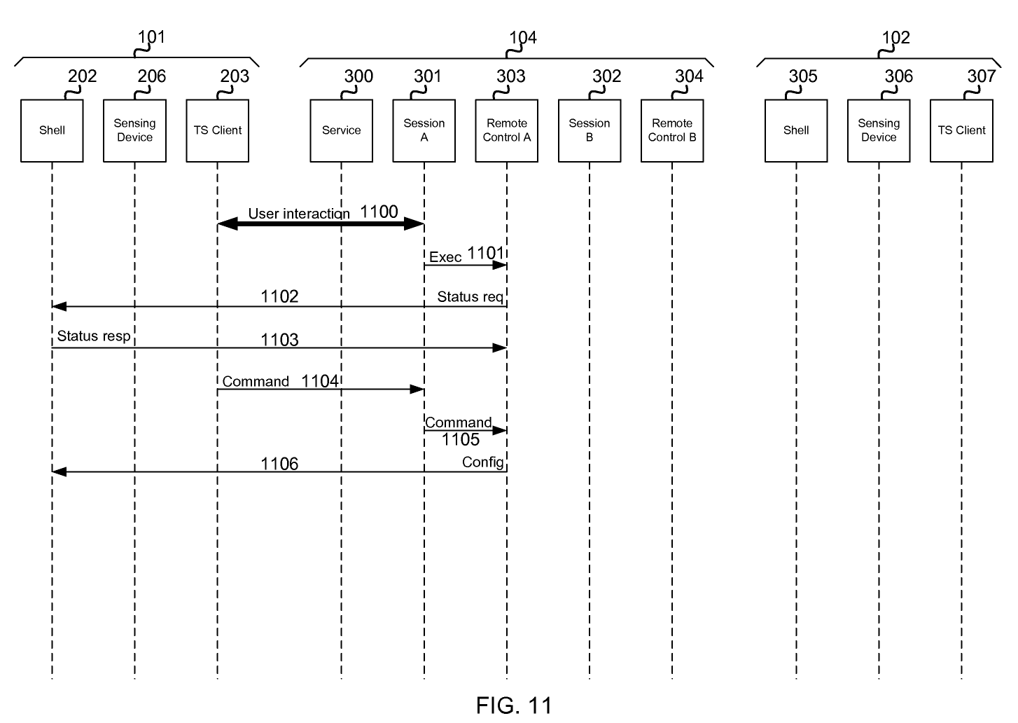

Reference is now made to FIG. 11, which illustrates a process by which the user can change settings on the thin client device 101 using the remote control application on the server 104. Whilst the user is engaged in a session 1100 (e.g. session A 301) the user can select an option displayed within the session to execute the remote control application. When this option is selected, session A 301 executes 1101 remote control A 303 (if it is not already running). Remote control A 303 sends a request 1102 for the current device status to the shell 202, and receives a response 1103 from the shell 202. In an alternative example, the shell 202 can be arranged to periodically report the status of the thin client device to the remote control A 303, in which case request 1102 is not required.

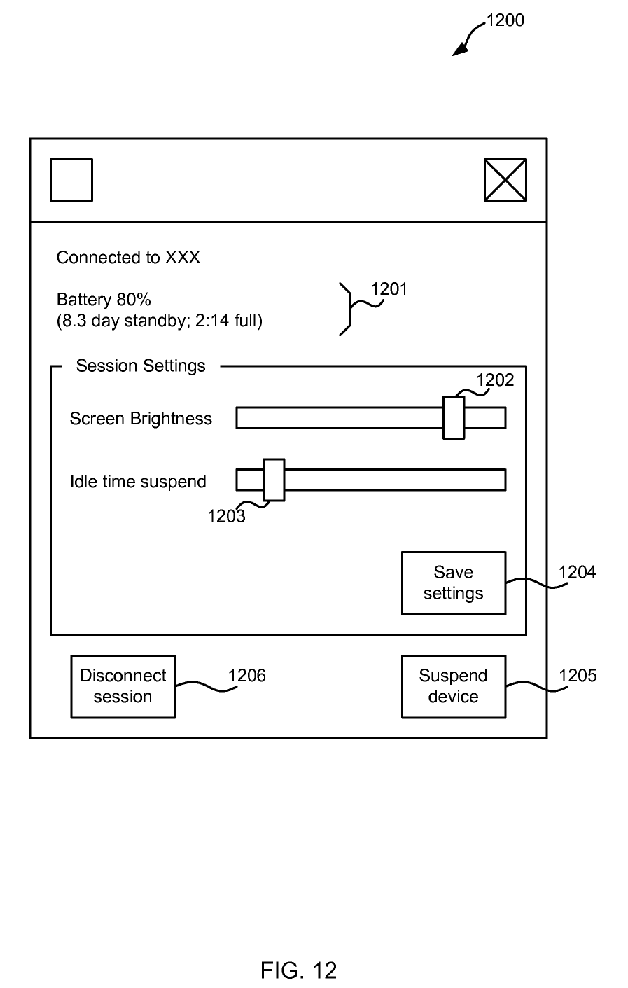

The user then sees a graphical user interface for the remote control application displayed within the session on the thin client device 101. An example graphical user interface dialog 1200 for the remote control application is shown illustrated in FIG. 12. The dialog 1200 displays the current status of the thin client device 101, including for example the current battery status 1201, as obtained from the shell 202. The user can use the dialog to set the parameters of the thin client device, for example using a screen brightness control 1202 and an idle time suspend control 1203. The user can save these settings with save button 1204. The user can also use the dialog 1200 to place the thin client device 101 into a power-saving suspend mode using suspend device button 1205, and disconnect the session using disconnect button 1206.

Returning again to FIG. 11, the user can interact with the dialog 1200 using the thin client device 101 via the TS client 203, and send a command 1104 (e.g. by selecting a control, such that the command comprises the coordinates of the selection on the screen). The command 1104 is received at session A 301 and interpreted as the selection of a particular control, and notification that this control was selected is passed 1105 to remote control A 303. The selection of the control is interpreted by remote control A 303 and a configuration message 1106 is sent to the shell 202. The shell 202 then applies the particular configuration to the thin client device 101.

Reference is now made to FIG. 13, which illustrates three examples of docking stations that can be used with the thin client devices. As mentioned above, the docking stations can be arranged to power and/or recharge the thin client devices, or provide a way of holding the thin client device at a certain useful position/orientation, or provide connectivity for extra peripherals for the thin client device. Docking stations can also be associated with specific sessions.

The first example 1300 is in the form of a cradle 1301 arranged to be positioned on a surface, and into which thin client devices can be inserted. The cradle 1301 can be arranged to hold a single thin client device, or cradles can also be arranged to hold a plurality of thin client devices, as shown in FIG. 13. Where a plurality of thin client devices are present, the front-most thin client device automatically displays the associated session, while thin client devices behind the front one can be in a low-power mode (i.e. not displaying anything or associated to a session) and can just be recharging. Removing the front-most thin client device is detected by the server 104, and the session selection algorithm automatically causes the thin client device behind to show the associated session. Similarly, when a thin client device is added to the front of the cradle this causes the newly added thin client device to associate with the appropriate session and the one behind (which was previously associated) is disassociated.

The second example 1302 is in the form of a frame 1303 arranged to be mounted on a wall, and into which the thin client device is inserted, and is thus similar to a picture frame. Like the cradle 1301 above, the frame 1303 can be arranged to hold a plurality of thin client devices, and only display the associated session on the front-most one.

The third example 1304 is in the form of a rack 1305, where the thin client devices are inserted lengthways. This is intended for placement on, for example, a bookshelf, and enables the thin client devices to be stored and/or recharged without taking up too much space. In this example, the thin client devices are not arranged to display any session when inserted in the rack 1305, as the thin client device displays are not visible.

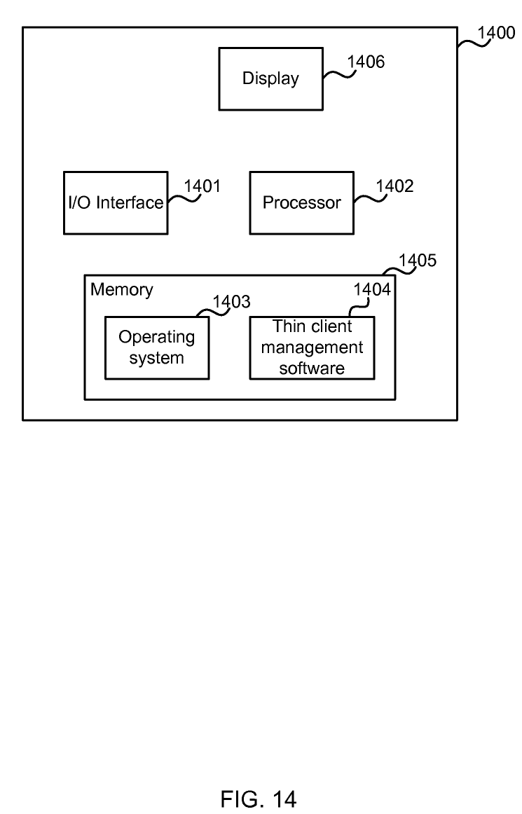

FIG. 14 illustrates various components of an exemplary computing-based device 1400 which can be implemented as any form of a computing and/or electronic device, and in which the functionality of the server 104 described above can be implemented.

The computing-based device 1400 comprises an input/output interface 1401 which is of any suitable type for data communication, for example Internet Protocol (IP) communication.

Computing-based device 1400 also comprises one or more processors 1402 which can be microprocessors, controllers or any other suitable type of processors for processing computing executable instructions to control the operation of the device in order to manage and support the thin client devices. Platform software comprising an operating system 1403 or any other suitable platform software can be provided at the computing-based device to enable thin client management software 1404 (including the service, sessions and remote controls as described above) to be executed on the device.

The computer executable instructions can be provided using any computer-readable media, such as memory 1405. The memory is of any suitable type such as random access memory (RAM), a disk storage device of any type such as a magnetic or optical storage device, a hard disk drive, or a CD, DVD or other disc drive. Flash memory, EPROM or EEPROM can also be used.

An output is also provided such as an audio and/or video output to a display system 1406 integral with or in communication with the computing-based device. The display system 1406 can provide a graphical user interface, or other user interface of any suitable type although this is not essential.

The term ‘computer’ is used herein to refer to any device with processing capability such that it can execute instructions. Those skilled in the art will realize that such processing capabilities are incorporated into many different devices and therefore the term ‘computer’ includes PCs, servers, mobile telephones, personal digital assistants and many other devices.

The methods described herein can be performed by software in machine readable form on a tangible storage medium. The software can be suitable for execution on a parallel processor or a serial processor such that the method steps can be carried out in any suitable order, or substantially simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer can store an example of the process described as software. A local or terminal computer can access the remote computer and download a part or all of the software to run the program. Alternatively, the local computer can download pieces of the software as needed, or execute some software instructions at the local terminal and some at the remote computer (or computer network). Those skilled in the art will also realize that by utilizing conventional techniques known to those skilled in the art that all, or a portion of the software instructions can be carried out by a dedicated circuit, such as a DSP, programmable logic array, or the like.

Any range or device value given herein can be extended or altered without losing the effect sought, as will be apparent to the skilled person.

It will be understood that the benefits and advantages described above can relate to one embodiment or can relate to several embodiments. The embodiments are not limited to those that solve any or all of the stated problems or those that have any or all of the stated benefits and advantages. It will further be understood that reference to ‘an’ item refers to one or more of those items.

The steps of the methods described herein can be carried out in any suitable order, or simultaneously where appropriate. Additionally, individual blocks can be deleted from any of the methods without departing from the spirit and scope of the subject matter described herein. Aspects of any of the examples described above can be combined with aspects of any of the other examples described to form further examples without losing the effect sought.

The term ‘comprising’ is used herein to mean including the method blocks or elements identified, but that such blocks or elements do not comprise an exclusive list and a method or apparatus can contain additional blocks or elements.

It will be understood that the above description of a preferred embodiment is given by way of example only and that various modifications can be made by those skilled in the art. The above specification, examples and data provide a complete description of the structure and use of exemplary embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention.

1. A method of automatically connecting a thin client device to a session on a server, comprising:
receiving data from the thin client device, the data indicating at least one sensed usage context for the thin client device;
analyzing the received data and selecting the session from a plurality of available sessions in dependence on the received data; and
transmitting a command to the thin client device instructing the thin client device to connect to the selected session.

2. A method as claimed in claim 1, wherein the sensed usage context indicates the location of the thin client device.

3. A method as claimed in claim 2, wherein the location of the thin client device relates to at least one of: the placement of the thin client device in a docking station; a geographical position of the thin client device; and the proximity of the thin client device to a known radio frequency source.

4. A method as claimed in claim 2, wherein the step of analyzing the received data comprises determining the location of the thin client device, and the step of selecting the session comprises selecting the session associated with the location from the plurality of available sessions on the server.

5. A method as claimed in claim 1, wherein the sensed usage context indicates that the thin client device has moved from a known location.

6. A method as claimed in claim 5, further comprising the steps of:
receiving further data from a further thin client device connected to the session at the server, the data indicating that the further thin client device has moved to the known location; and
transmitting a command from the server to the further thin client device instructing the further thin client device to disconnect from the session.

7. A method as claimed in claim 1, wherein the sensed usage context indicates an identity of a user of the thin client device.

8. A method as claimed in claim 7, wherein the step of analyzing the received data comprises determining the identity of the user, and the step of selecting the session comprises selecting the session from the plurality of available sessions on the server associated with the user.

9. A method as claimed in claim 1, further comprising the step of executing a remote control program at the server arranged to transmit commands to the thin client device to configure the thin client device hardware operation.

10. A method as claimed in claim 9, wherein the commands configure at least one of: display brightness; and system idle time of the thin client device.

11. A method as claimed in claim 1, wherein the steps of receiving data, analyzing the received data, selecting the session, and transmitting a command are performed on the server.

12. A method as claimed in claim 1, further comprising the step of determining whether the received data is sufficient for the thin client device to connect to the selected session without further authorization.

13. A method as claimed in claim 1, further comprising receiving further data from a further thin client device and determining whether a combination of the received data and the further data is sufficient for the thin client device to connect to the selected session without further authorization.

14. A method as claimed in claim 1, further comprising the step of determining whether the thin client device previously disconnected from the selected session within a predefined time interval, and if so, enabling the thin client device to connect to the selected session without further authorization.

15. A thin client device, comprising:
a processor;
a network interface;
a sensing device arranged to provide data to the processor indicating at least one sensed usage context for the thin client device; and
a memory arranged to store executable instructions arranged to cause the processor to: connect to a server using the network interface; transmit the data to the server; and receive a command to establish a connection with a specified session.

16. A thin client device according to claim 15, wherein the sensing device comprises a dock connection sensor arranged to identify a docking station in which the thin client device is located, and wherein the data comprises an identity of the docking station.

17. A thin client device according to claim 15, wherein the sensing device further comprises at least one of: a biometric sensor; an accelerometer; a global positioning system sensor; a short-range radio transceiver; and a radio frequency identification reader.

18. A thin client device according to claim 15, wherein the network interface is a wireless network interface.

19. A method of automatically connecting a thin client device to a session on a server, comprising:
receiving data from the thin client device at the server, the data indicating that the thin client device has moved from a known location;
receiving further data from a further thin client device connected to the session at the server, the data indicating that the further thin client device has moved to the known location;
transmitting a command from the server to the further thin client device instructing the further thin client device to disconnect from the session; and
transmitting a command from the server to the thin client device instructing the thin client device to connect to the session.

20. A method according to claim 19, further comprising the step of determining whether the further data from the further thin client device was received at the server within a predefined time period from the receipt of the data from the thin client device.
